(19) United States
(12) Patent Application Publication
(10) Pub. No.: US 2021/0356350 A1
(43) Pub. Date: Nov. 18, 2021

(54) METHOD AND DEVICE FOR IDENTIFYING THE OCCURRENCE OF A DEFECT IN A PIPELINE BY MEANS OF ESTIMATION

(71) Applicant: Siemens Energy Global GmbH & Co. KG, Munich, Bayern (DE)

(72) Inventors: Michael Hornacek, Wien (AT); Daniel Schall, Hollabrunn (AT)

(73) Assignee: Siemens Energy Global GmbH & Co. KG, Munich, Bayern (DE)

(21) Appl. No.: 17/278,294

(22) PCT Filed: Sep. 24, 2019
(86) PCT No.: PCT/EP2019/075725

§ 371 Date: Mar. 20, 2021

(30) Foreign Application Priority Data
Sep. 27, 2018 (EP) 18197085.6

(51) Int. Cl. G01M 3/16; G01M 3/28; G01M 3/38; G01N 21/954

(52) U.S. Cl. CPC G01M 3/16; G01N 21/954; G01M 3/38; G01M 3/2815

(57) ABSTRACT

A method for identifying the occurrence of a defect in a pipeline by estimation, wherein at least one first indicator is identified by a first detector assigned to a first detection location, from which a first estimation value regarding the occurrence of the defect in the pipeline is determined, and at least one second indicator is identified by at least one second detector assigned to a second detection location, from which at least one second estimation value regarding the occurrence of the defect in the pipeline is determined. An overall estimation value is determined from the first estimation value and the at least one second estimation value by an overall estimation function by taking into account the respective positions of the first detection location and the second detection location, from which overall estimation value the occurrence of the defect is estimated.

### CROSS REFERENCE TO RELATED APPLICATIONS

This application is the US National Stage of International Application No. PCT/EP2019/075725 filed 24 Sep. 2019, and claims the benefit thereof. The International Application claims the benefit of European Application No. EP18197085 filed 27 Sep. 2018. All of the applications are incorporated by reference herein in their entirety.

### FIELD OF INVENTION

The invention relates to a method and an apparatus for ascertaining the occurrence of a defect in a line by means of estimation.

### BACKGROUND OF INVENTION

Lines for transporting fluid media, such as liquids or gases, are frequently laid underground, for example in order to protect the line from adverse external influences and to improve a visual appearance for local residents, in particular in the case of very long lines, such as pipelines. However, this type of laying also entails a series of problems. Lines frequently experience undesirable faults in the form of leaks and overflows of water, oil or gas, these possibly leading to extensive environmental damage, which in some cases can be put right only with difficulty or not at all, but almost always leads to very serious and very expensive cleanup measures.

The publication Kishaway, Hossam A., and Hossam A. Gabar, “Review of pipeline integrity management practices.”, International Journal of Pressure Vessels and Piping 87.7 (2010), pages 373-380, describes various currently used methods for detecting and avoiding leaks. It reveals that prevention begins as early as with the suitable installation of the pipeline, since just minor damage to the line such as dents can promote the occurrence of small cracks. During operation of the line, the following systems for sensing line faults can be used in the prior art:

1. Supervisory Control and Data Acquisition (SCADA): for monitoring the flow or pressure of the medium in the line, appropriate sensors being arranged in pump stations of the line. SCADA is generally understood to mean the monitoring and control of technical processes by means of a computer system.

2. Measuring lines, for example comprising optical fibers, which can be used as sensor element in order to detect extremely small tremors and to sense movements in proximity to the line.

3. Insertion of apparatuses into the line (known as “smart pigs”) and inundation with the medium, for example in order to obtain corrosion data for the line.

4. Overflying the line and determining the depth of cover or vegetative changes over the line, and using specially trained sniffer dogs for detecting leaks.

The first two variants are continuous leak locating systems that permit continual monitoring of leaks on lines. A distinction can be drawn here between external and internal systems. Internal systems can be fiber optic sensors, acoustic sensors, sensor tubes and video monitoring, for example. External systems can use a pressure point analysis or the mass balance method (difference between mass flow and mass loss), for example, or be based on statistical systems, “realtime transient model” (RTTM) or “extended realtime transient model” (E-RTTM) based systems.

Variants 3 and 4 are discontinuous leak locating systems that are implemented only when required and do not permit permanently continual monitoring of leaks.

The publication Guerriero Marco et al.: “Bayesian data fusion for pipeline leak detection”, 2016 19th International Conference on Information Fusion (FUSION), ISIF, July 5, 2016, pages 278-285, XP032935023, and US 2017/076563 A1 (Guerriero M [US] et al.), March 16, 2017, disclose a method for ascertaining the occurrence of a defect in a line by means of estimation. The proposal is to combine an estimation algorithm for detection and an estimation algorithm for location with one another by using a dynamic Bayesian network (DBN).

Two heterogeneous systems are combined with one another, namely “fiber optic Distributed Acoustic Sensing” (DAS) and “Internal Leak Detection (ILD)” technology. ILD technology typically exhibits low sensitivity and poor location. DAS technology, on the other hand, typically exhibits relatively high sensitivity, but a high false alarm rate. The aim of combining ILD and DAS technology is to achieve high sensitivity with a simultaneously low false alarm rate.

However, DAS technology is not always available, too complicated or not retrofittable in an economically viable manner.

### SUMMARY OF INVENTION

It is an object of the invention to improve the reliability of a detection of a defect compared to the prior art using simple means.

The object is achieved by a method of the type cited at the outset in that

a first indicator is ascertained by a first sensing means assigned to the line by applying at least one first sensing parameter, from which a first estimated value with regard to the occurrence of the defect in the line and a first sensing location are determined by means of a first estimation function,

and at least one second indicator is ascertained by at least one respective locally sensing second sensing means assigned to a second sensing location by applying at least one second sensing parameter, from which at least one second estimated value with regard to the occurrence of the defect in the line is determined by means of at least one second estimation function, wherein the first sensing parameter and the at least one second sensing parameter are chosen such that a first mode of operation is configured for the first sensing means and/or the at least one second sensing means, and an overall estimated value is determined from the first estimated value and the at least one second estimated value by means of an overall estimation function by taking into consideration the respective bearing of the first sensing location and of the respective second sensing location, from which the occurrence of the defect is assessed, and if a threshold value for the estimation for the occurrence of the defect is exceeded on the basis of the overall estimated value then a second mode of operation is determined for the first sensing means and/or the at least one second sensing means, which second mode of operation is configured by means of the at least one first sensing parameter and the at least one second sensing parameter, and the overall estimated value is re-determined on the basis of the second mode of operation and the occurrence of the defect is re-assessed therefrom.

The effect achieved by this is that a fault can be ascertained using an incremental method by virtue of an estimation of the event first being effected in a first mode of operation, and detection resulting in a further, specifically adapted estimation being effected in a second mode of operation. This allows the reliability and accuracy of a detection to be improved. In other words, a two-stage method is used to improve the reliability of a detection. The two-stage method therefore comprises a first stage and a second stage for the estimation.

A simple second sensing means can be used in this case, since only the occurrence of the defect is assessed and no locating needs to be performed during operation, since the sensing location is known from the mounting or installation position of the second sensing means.

The sensing means have at least two modes of operation, for example a “monitoring mode”, in which statistical monitoring and evaluation of the system for a fault event are effected over a lengthy period in order to reject brief faults and to make the system more robust and more reliable, and a “fault mode”, in which optimized parameterization is used to perform a further estimation that permits an improved statement with regard to the type and position of the detected defect.

The respective sensing locations have been determined beforehand, and are known, from the installation locations of the sensors, or the geographical areas thereof covered by the respective sensor.

An estimation function for forming an estimated value, also estimation statistic or estimator for short, is used in mathematical statistics to ascertain an estimated value on the basis of available empirical data of a random sample and to obtain information regarding unknown parameters of a population as a result. Estimation functions are the basis for calculating point estimations and for determining confidence ranges by means of area estimators and are used as test statistics in hypothesis tests. They are specific random sample functions and can be determined by methods of estimation, for example least squares estimation, maximum likelihood estimation or method of moments.

Furthermore, it is beneficial if in the second mode of operation an additional third sensing means is used, that is to say a sensing means that is not yet used in the first mode of operation, in order to improve the estimation with regard to accuracy and/or susceptibility to interference, for example.

The number of sensing means used can therefore be higher in the second mode of operation than in the first mode of operation.

It is therefore possible for a third indicator to be ascertained by a third sensing means assigned to the line by applying at least one third sensing parameter, from which a third estimated value with regard to the occurrence of the defect in the line and a third sensing location are determined by means of a third estimation function, and in addition to the first estimated value and the at least one second estimated value the third estimated value the overall estimated value is determined by means of the overall estimation function by taking into consideration the respective bearing of the first, second and third sensing locations, from which the occurrence of the defect is assessed.

The invention is also achieved by an apparatus of the type cited at the outset comprising at least one first sensing means, assigned to a first sensing location, that is designed to use a first estimation function to determine a first estimated value as at least one first indicator, and at least one second sensing means, assigned to a second sensing location, that is designed to use at least one second estimation function to determine at least one second estimated value as at least one second indicator, and an analysis apparatus having a processor and a memory, which analysis apparatus is designed to determine estimated values, wherein the first and second sensing means are connected to the analysis apparatus, and wherein the apparatus is designed to carry out the method described above.

In one of development of the invention there is provision for the overall estimated value on the basis of the first mode of operation and the overall estimated value on the basis of the second mode of operation to be correlated with one another.

This allows a resultant overall estimated value for the method to be determined that improves the reliability and accuracy further.

In one of development of the invention there is provision for the first mode of operation to provide for a sensing by means of the first indicator and the at least one second indicator that involves the at least one first sensing parameter and the at least one second sensing parameter being chosen such that the reliability of the sensing is optimized.

The effect achieved by this is that the reliability of the method is improved. The reliability can be described for example by using statistical quantities when considering the indicators over time. Furthermore, this can be achieved by advantageously using appropriate adaptation of the sampling frequency for the sensing of the indicators by the sensing means.

In one development of the invention there is provision for the first mode of operation to provide for a sensing by means of the first indicator and the at least one second indicator that involves the at least one first sensing parameter and the at least one second sensing parameter being chosen such that the current draw of the sensing is optimized. This can be achieved for example by means of appropriate adaptation of the sampling intervals for the sensing of the indicators by the sensing means, or else by means of selective connection of more sensitive sensors or electronic amplifiers in the sensing means.

The effect achieved by this is that the operating properties are improved and the operating costs of the method are reduced. The operating costs can be for example resources needed for data capture, data storage, statistical data evaluation or else current or power draw by an applicable apparatus.

In one development of the invention there is provision for the second mode of operation to provide for a sensing by means of the first indicator and the at least one second indicator that involves the at least one first sensing parameter and the at least one second sensing parameter being chosen such that the accuracy of the sensing is optimized.

The effect achieved by this is that the accuracy of the method is improved. As explained previously, operating properties can be improved or operating costs of the method can be reduced.

A combination of the previously mentioned first and second modes of operation achieves an improvement in the method, which permits an improved, reliable and at the same time accurate detection of faults.

It is advantageous if the line is an oil, gas or water line, since such lines in the prior art are already used via a series of sensors for monitoring the line and it is therefore a simple matter to implement the merging of the combined, two-stage evaluation of multiple indicators, in particular for already existing lines and associated sensor systems.

In one development of the invention there is provision that if the threshold value for the estimation for the occurrence of the defect is exceeded then a hypothesis for the type and/or bearing of the defect is determined that is used for determining the at least one first sensing parameter and the at least one second sensing parameter.

The effect achieved by this is that a configuration for the sensing of the indicators in the second mode of operation verifies the hypothesis, and the estimation of the defect is effected in an efficient manner as a result.

It is also advantageous if the defect is a leak in the line. It is therefore possible for sensors of particularly simple design, and already existing sensors of lines, to be used in the arrangement.

Furthermore, it is advantageous if the defect is influenced by an event outside the line that is detected. In other words, the detected defect can concern for example soil surrounding the line, mounting elements or connecting elements such as screws that are secured to the line or connect the line to other parts. This allows faults to be sensed preventively before damage occurs directly in the line, for example as a result of the line being undermined by a temporary flow of water from a severe thunderstorm or by a landslide.

In one development of the invention the position of the defect in or on the line is assessed from the overall estimated value. The overall estimated value is determined from the previously determined estimated values, in each of which the position of the defect is also determinable. Only a joint review of the individual estimated values of the first stage with the respective positions of the joint defect allows the accuracy of the position determination of the estimations of the first stage to be improved overall in the second stage of the two-stage method. It is possible to determine an estimated value of the position of the defect both in the line and in the adjoining surroundings of the line, for example soil surrounding the line, as explained previously.

In one development of the invention, the first estimated value is determined by means of the first estimation function and/or the at least one second estimated value is determined by means of the at least one second estimation function by an analysis apparatus. The calculation of the respective estimated values in the analysis apparatus allows the respective sensing apparatuses and the development thereof to be simplified.

In one development of the invention, the first sensing location of the first sensing means and the second sensing location of the at least one second sensing means are situated adjacently to one another and to the line, advantageously within a distance of 40 m, more advantageously within 20 m and particularly advantageously within 10 m. The effect that can be achieved by appropriate positioning of the respective sensing means is that the determination of the position of defects is more accurate.

In one development of the invention, the first sensing means and/or the at least one second sensing means are formed by the performance of a visual inspection of the line, advantageously in the second mode of operation. The effect achieved by this is that for example the type and quality of the vegetation over a buried line is easily analyzable, in particular if the visual inspection is effected from the air for example using a drone or a helicopter. The visual inspection is advantageously effected using an imaging sensor in the optical and/or infrared range while at the same time determining the position of the inspection location.

It is beneficial if a more detailed visual inspection is performed in the second mode of operation, for example by virtue of a re-sensing by means of an airborne sensing means. The estimation from the first mode of operation can be used as a basis for example for narrowing down the location for performing the sensing in the second mode of operation and for performing said sensing at a lower altitude in order to capture more accurate and more detailed data that are subsequently processed further. Parameters for the second mode of operation can therefore also comprise the altitude, the recording path or the spectral sensitivity (such as UV, IR or optical spectrum) of the sensor of the airborne sensing means, for example.

In one development of the invention, the first sensing means and/or the at least one second sensing means are formed by the performance of a ground analysis of the surroundings of the line. The effect achieved by this is that for example the contamination of the ground by the medium carried in the line above, beside or below a buried line is easily analyzable, in particular by a moisture sensor.

In one development of the invention, the first sensing means is formed by an analysis apparatus for weather data. Weather data can be forecast data, present or already past weather influences. These data can either be determined manually or can be ascertained by weather simulations of a computer-aided weather service. Local weather data at a specific location are ascertained in this case, such as for example hail, floods, storms or hotspots.

In one development of the invention, the first sensing means is formed by an analysis apparatus for environmental data. The environmental data can be analysis data that come or are derived from satellite-based imaging sensors, for example maps of stretches of water, burnt regions, flooding or land subsidence. Environmental data can be data from satellite-based data services such as Copernicus (http://www.copernicus.eu/main/services), and can contain for example data regarding the atmosphere, regarding climate change, regarding the marine environment or land data.

In one development of the invention, the first indicator and the at least one second indicator represent mutually independent physical measured quantities, advantageously pressure, motion and temperature. A movement can be sensed for example by motion sensors or acceleration sensors.

In one development of the invention, the first indicator and the at least one second indicator represent a change of physical properties of the line, advantageously material properties or properties regarding the ageing of material. The applicable properties or the changes thereof can be stored in a model or a database.

In one development of the invention, the overall estimation function is a Bayesian estimation function. This provides a simple way of realizing an improved two-stage estimation, and application of a Bayesian network allows the line and the indicators thereof to be modeled particularly clearly.

A Bayes estimator in mathematical statistics is an estimation function that, in addition to the observed data, takes into consideration any available prior knowledge about a parameter that needs to be estimated. According to the Bayesian statistics approach, this prior knowledge is modeled by a distribution for the parameter, the a priori distribution. Bayes' theorem yields the conditional distribution of the parameter among the observation data, the a posteriori distribution. In order to obtain a unique estimated value therefrom, location measures of the a posteriori distribution, such as expectation value, mode or median, are used as what are known as Bayes estimators. Since the a posteriori expectation value is the most important and in practice the most frequently used estimator, some authors also refer to it as the Bayes estimator.

Generally, a Bayes estimator is defined as that value that minimizes the expectation value for a loss function among the a posteriori distribution. For a quadratic loss function, the a posteriori expectation value itself is then obtained as estimator.

### BRIEF DESCRIPTION OF THE DRAWINGS

The invention is explained in more detail below on the basis of an exemplary embodiment depicted in the accompanying drawings, in which:

FIG. 1 shows a schematic depiction of an apparatus for estimating the occurrence of a defect on a line according to the invention,

FIG. 2 shows a schematic depiction of a Bayesian network for use in a method according to the invention.

### DETAILED DESCRIPTION OF INVENTION

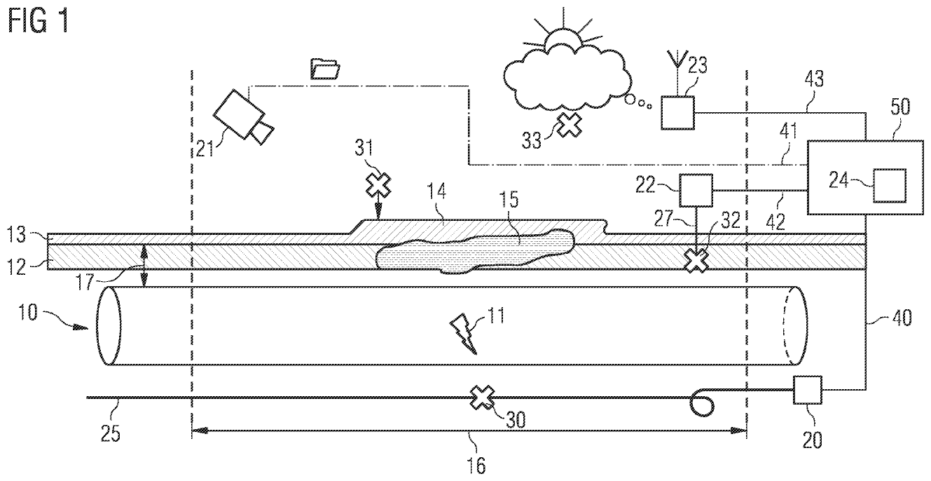

FIG. 1 schematically shows an exemplary embodiment of an arrangement having a line 10 provided for the long-distance transport of oil. FIG. 1 shows the arrangement for estimating the occurrence of a defect 11, for example a leak as a result of a crack in the line 10, according to the invention, wherein the line 10 is incorporated in the ground 12 and covered with soil, and a vegetation 13, for example a meadow, further covers the ground 12.

The apparatus comprises a first sensing means 20 in the form of a line sensor having a measuring line 25 that runs adjacently to the line 10. The measuring line 25 can be used to ascertain a defect 11, for example by sensing a change in the resistance of the measuring line 25 in the soil, and the location of the resistance change as a first sensing location 30.

The sensing of the resistance change can be effected as first indicator 40 by the first sensing means 20, for example by measuring reflections of a radio-frequency signal fed into the measuring line 25 that arise at the first sensing location 30 as a result of the effect of the leak at the defect 11 in the line 10.

The first sensing means 20 is connected to an analysis apparatus 50 by wire or wirelessly for the purpose of transmitting the first indicator 40 and the first sensing location 30.

The analysis apparatus 50 is designed to determine a first estimated value from the first indicator 40 by means of a first estimation function. Alternatively, the first estimated value can also be determined by the first sensing means 20, and the first estimated value can be transmitted to the analysis apparatus 50 for further use.

Furthermore, the apparatus comprises a second sensing means 21 in the form of a camera that is designed to perform a visual inspection of the line 10. The camera is an imaging sensor that is sensitive in the optical and infrared ranges, for example. The camera can be moved along the line 10 by means of a drone or a helicopter, for example, and can capture the vegetation 13 or the surroundings immediately above the line 10. Changes in the vegetation 14 at a second sensing location 31 can be combined in the form of camera shots with position data from a GPS system, sensed as second indicator 41 and transmitted to the analysis apparatus 50.

The analysis apparatus 50 is designed to determine a second estimated value from the second indicator 41 by means of a second estimation function.

In this exemplary embodiment, the apparatus additionally comprises a third sensing means 22 having a ground moisture sensor 27 that is designed to sense the relative moisture in the ground at a third sensing location 32 as third indicator 42. In other words, a ground analysis of the surroundings of the line 10 can be effected by the moisture sensor 27.

The third sensing means 22 is connected to an analysis apparatus 50 by wire or wirelessly for the purpose of transmitting the third indicator 42 and the third sensing location 32.

The analysis apparatus 50 is designed to determine an overall estimated value from the third indicator 42 by means of an overall estimation function.

The apparatus also comprises a fourth sensing means 23 in the form of a computer-aided weather service that is designed to forecast local weather data at a fourth sensing location 33 or to determine present or already past weather influences and to transmit them to the analysis apparatus 50 as fourth indicator 43. The local weather influences can be hail, floods, storms or hotspots, for example.

The analysis apparatus 50 is designed to determine a fourth estimated value from the fourth indicator 43 by means of a fourth estimation function.

The apparatus in this example comprises a fifth sensing means 24 in the form of a database, in which properties regarding the ageing of physical material properties of sections of the line 10 form a fifth indicator. The database additionally contains an assigned and stored fifth sensing location for the position of the applicable section of the line 10.

The analysis apparatus 50 forms a SCADA system and is designed to determine a fifth estimated value from the fifth indicator by means of a fifth estimation function.

It is clear that the sensing locations 30-33 of the respective sensing means 20-24 are previously known and can be static. For these cases, the positions of the respective sensing locations 30-33 can be stored in a memory in the analysis apparatus 50 and can be assigned to the respective sensing means 20-24 for further use, the sensing means then only conveying the respective indicators 40-43 to the analysis apparatus 50.

The analysis apparatus 50 is further designed to determine an overall estimated value from the first estimated value, the second estimated value, the third estimated value, the fourth estimated value and the fifth estimated value by means of an overall estimation function, for example by using a Bayes estimator, by taking into consideration the respective bearing of the first sensing location 30, the second sensing location 31, the third sensing location 32, the fourth sensing location 33 and the fifth sensing location, from which overall estimated value the occurrence of the defect 11 or the position thereof is able to be assessed.

In one exemplary embodiment of the method, a first indicator 40 is ascertained by a first sensing means 20 assigned to the line by applying at least one first sensing parameter, from which a first estimated value with regard to the occurrence of the defect 11 in the line 10 and a first sensing location 30 are determined by means of a first estimation function.

Furthermore, at least one second indicator 41-43 is ascertained by at least one respective locally sensing second sensing means 21-23 assigned to a second sensing location 31-33 by applying at least one second sensing parameter, from which at least one second estimated value with regard to the occurrence of the defect 11 in the line 10 is determined by means of at least one second estimation function.

The first sensing parameter and the at least one second sensing parameter are chosen such that a first mode of operation is configured for the first sensing means 20 and/or the at least one second sensing means 21-23.

Furthermore, an overall estimated value is determined from the first estimated value and the at least one second estimated value by means of an overall estimation function by taking into consideration the respective bearing of the first sensing location 30 and of the respective second sensing location 31-33, from which the occurrence of the defect 11 is assessed.

On the basis of the overall estimated value a second mode of operation is determined for the first sensing means 20 and/or the at least one second sensing means 21-23, which second mode of operation is configured by means of the at least one first sensing parameter and the at least one second sensing parameter.

The overall estimated value is re-determined on the basis of the second mode of operation and the occurrence of the defect 11 is re-assessed therefrom.

The two-stage estimation according to the invention allows mutually independent indicators to be combined with one another and a precise estimation of defects to be rendered possible, the indicators being able to be independent physical measured quantities, such as for example pressure, motion and temperature. The sensing means 20-23 can therefore be a pressure sensor, an acceleration sensor, a temperature sensor or the like, it being clear that there must additionally be provision for appropriate sensor evaluation electronics in order to capture the sensor values as appropriate indicators.

The first mode of operation provides for a sensing by means of the first indicator 40 and the at least one second indicator 41-43 that involves the at least one first sensing parameter and the at least one second sensing parameter being chosen such that for example the reliability or the current draw of the sensing is optimized.

The second mode of operation provides for a sensing by means of the first indicator 40 and the at least one second indicator 41-43 that involves the at least one first sensing parameter and the at least one second sensing parameter being chosen such that for example the accuracy of the sensing is optimized.

The overall estimated value on the basis of the first mode of operation and the overall estimated value on the basis of the second mode of operation can be correlated with one another.

The method according to the invention can be more accurate if the sensing locations 30-33 of the respective sensing means 20-24 are situated adjacently to one another and to the line 10, advantageously within a distance 16 of 40 m, more advantageously within 20 m and particularly advantageously within 10 m.

The distance 16 is advantageously the diameter of an imaginary circle in which both the position of the leak and the position of the sensing locations 30-33 of the respective sensing means 20-24 are situated.

A degree of cover 17 is defined by the depth of the line below the covering earth's surface, that is to say the vertical distance from the top of the pipeline to the surface of the ground.

Furthermore, the method according to the invention is suitable for detecting defects 11 that are influenced by an event outside the line (10), such as for example undermining of the line 10 by a stretch of running water.

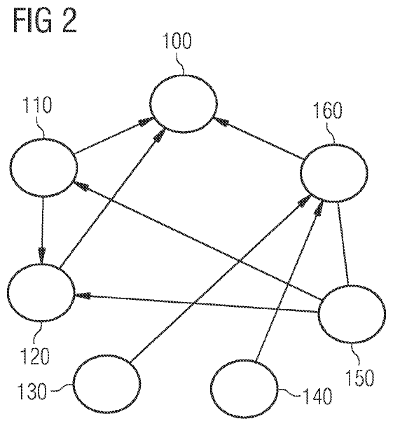

FIG. 2 shows an exemplary embodiment to describe a modeling of the method according to the invention on the basis of a Bayesian network.

The design of the invention provides for inherently heterogeneous information to be connected by a standard model. This can be used to assist an operator of an oil pipeline in his conclusions and decisions.

Bayesian networks provide a formal basis for the integration of information and inferences from events. A Bayesian network is a graphical model that can be described as a directional acyclic graph, wherein nodes represent discrete random variables and directional arrows represent dependencies between variables within the meaning of conditional probabilities.

A Bayesian network can easily allow distribution of expert knowledge and empirical data in models with Bayesian networks. Bayesian networks are moreover robust in the face of erroneous, missing and scattered data. Furthermore, Bayesian networks permit a semantic interpretation from their own data, as a result of which it is possible to derive a trusted and secure relationship with the data used.

The model in FIG. 2 can answer enquiries with regard to the “health” or integrity of a section of a pipeline that can be described by the node HEALTH 100.

A section can be defined very flexibly, for example as the distance between two pumping stations, in order to achieve sufficient narrowing-down of information and alarms. In general, the integrity of a section of a pipeline can be a result of an analysis of SCADA events, earth observation data and events triggered by external activities, for example a nearby construction site.

In connection with oil, gas and water, a SCADA system can use a status node 110 to monitor flow and pressure values for a line and trigger appropriate alarms if a stipulated limit value is exceeded. The SCADA system in a similar form can be the analysis apparatus 50 and comprise the sensing means 20-24 of FIG. 1.

Statistically-based leak locating systems subject previously determined values for the indicators 40-43 to a respective statistical test. General statistical variables in this case can be formed from a pressure change over time or using the mass balance method. What is known as the hypothesis test is a frequently used method in this case.

If statistically-based leak locating systems that perform an evaluation of a SCADA system determine a leak with a high probability of certainty, the probability of the integrity of a pipeline section diminishing is often very high, in particular for concealed or incipient leaks. The SCADA node 110 in the model in FIG. 2 therefore has a direct reference to the HEALTH node 100.

Earth observation data allow the vegetative state of the ground covering the pipeline to be sensed. What is known as the “normalized difference vegetation index” (NDVI) can be applied in this regard, this being able to be sensed by airborne visual observation by means of a camera, for example. Individual camera images can each be assigned present position data for the camera from a GPS system in order to subsequently allow an automated evaluation and to create a geo-referenced electronic map of the NDVI. The NDVI is a simple and widely used vegetative health indicator. A geographically narrowed-down area with an NDVI raster can be calculated by means of a combination of aerial images of optical and near infrared (NIR) bands. On the basis of two overlapping layers of NDVI maps that come from different observations, a map containing NDVI changes that is able to be divided into polygons for areas of minimum and maximum change can be calculated pixel by pixel, for example. These polygons can be assigned numerous attributes, such as for example the surface area in square meters, which are in turn able to be used for filtering.

While an NDVI value or a change in the NDVI in the Bayesian model in FIG. 2 can sense that the vegetation is dying, which is possibly caused by a leak from the line, a single NDVI value or a change in the NDVI could lead to undesirable false alarms (“false positives”), which means that the sole NDVI value is rather unsuitable for locating leaks. In FIG. 2, an NDVI node 120 is therefore connected to the SCADA node 110, and to an ASSET node 150.

A SCADA alarm would intensify a problem that was detected by an NDVI change and would provide further information about the detected leak. Furthermore, the ASSET node 150 would likewise intensify the problem by adding information with regard to the corrosion state of the coating of the pipeline, as explained in more detail below.

The degree of cover, known as the “depth of cover” (DOC) or layer thickness, is the vertical distance from the top of the pipeline to the surface of the ground and is taken into consideration in the model in FIG. 2 by the node 130. Pipelines need to comply with minimum legal requirements at the time at which they are built, these requirements also possibly regulating the necessary cover. However, this cover can change over the course of time, for example as a result of excavation work, erosion, cultivation, construction activity, flooding, land subsidence or other environmental influences or influences by human beings.

A pipeline reference model and a terrain model that was ascertained from aerial photographs, for example, allows the determination of DOC in meters in reference to the terrain model. For a specific point, DOC is the difference between the terrain model and the pipeline reference model at this point, as known from WO 2017/174426 A1.

A further node 140 can be the weather (WEATHER). Weather data can be forecast data, present or already past weather influences. These data can either be determined manually or can be ascertained by weather simulations of a computer-aided weather service. Local weather data at a specific location are ascertained, such as for example hail, floods, storms or hotspots.

The ASSET node 150 contains all of the information with regard to the physical line, such as for example information in the form of a geo-referenced pipeline reference model, regarding the material properties of the line and potential corrosion parameters of the pipeline or sections thereof. The corrosion parameters can be sensed for example by means of different measurement techniques within the line, and by reliability and survival time models and analyses.

Node 150 connects node 110 (SCADA) and node 120 (NDVI). It is therefore possible for an alarm from the SCADA system to be additionally supported by data from the ASSET node (150) by virtue of an appropriately high probability of occurrence of for example an age-related corrosion at a specific point.

A further node 160 can take into consideration events (EVENTS), such as for example excavation work, cultivation, construction activity, flooding or earthquakes. The events can be sensed and classified for example by using fiber optic sensors. Events usually have a great influence on the “health” of the pipeline, which is modeled in the node 100 if the DOC node 130 is also regarded as critical. An operator needs to perform an evaluation in order to establish whether remedial measures are appropriate under the given circumstances.

Nodes 130 and 140 are advantageously connected to node 160 (EVENTS).

After the Bayesian model is trained and appropriate data are stored by a sensor network, for example in the form of an Internet of Things (IoT), it is possible for automatic and continual evaluation of the “health” of the pipeline to be effected, which is referred to as inference.

For example, node 100 (HEALTH) can comprise the following values: OK, DETERIORATED, SEVERE_DAMAGE.

A query to the SCADA system, for example the analysis apparatus 50 in FIG. 1, could then read as follows:
cpquery(pipeline_health_bn, event=(HEALTH==“SEVERE_DAMAGE”), evidence=(SCADA==“ALARM_PRESSURE_LOSS” & NDVI_CHANGE==“LARGE”)) with the following parameters according to FIGS. 1 and 2 defining the query by way of illustration: “pipeline_health_bn” is a Bayesian network model of the pipeline 10 with the health status of the HEALTH node 100. “event” defined for a specific health status of the HEALTH node 100, which is stipulated by the condition of an “evidence” parameter. The evidence parameter can be a linkage of multiple states of different nodes, such as for example the state “ALARM_PRESSURE_LOSS” of the SCADA node 110 and the state “LARGE” of the NDVI node 120.

The result for this case would be that the pipeline state of health is SEVERE_DAMAGE, supported by a report from the SCADA system, which has output an alarm from a pressure sensor of the SCADA system regarding a pressure loss, and the vegetation in the relevant area has a large change in the NDVI parameter that was ascertained by means of aerial photographs and a subsequent computer-aided evaluation.

### LIST OF REFERENCE SIGNS

10 line
11 defect, leak
12 ground
13, 14 vegetation, meadow
15 escape or accumulation of the medium
16 distance
17 degree of cover
20-24 sensing means
25 measuring line
27 moisture sensor
30-33 sensing location of the sensing means
40-43 indicator
50 evaluation apparatus
100 state of the line, HEALTH
110 SCADA system
120 vegetative state, normalized difference vegetation index, NDVI
130 state of cover, depth of cover, DOC
140 weather, WEATHER
150 physical state, properties of the line, ASSET
160 events, EVENTS

1. A method for ascertaining the occurrence of a defect in a line by means of estimation, the method comprising:
ascertaining a first indicator by a first sensing means assigned to the line by applying at least one first sensing parameter, from which a first estimated value with regard to the occurrence of the defect in the line and a first sensing location are determined by means of a first estimation function,
ascertaining at least one second indicator by at least one respective locally sensing second sensing means assigned to a second sensing location by applying at least one second sensing parameter, from which at least one second estimated value with regard to the occurrence of the defect in the line is determined by means of at least one second estimation function,
wherein the first sensing parameter and the at least one second sensing parameter are chosen such that a first mode of operation is configured for the first sensing means and/or the at least one second sensing means,
determining an overall estimated value is from the first estimated value and the at least one second estimated value by means of an overall estimation function by taking into consideration the respective bearing of the first sensing location and of the respective second sensing location, from which the occurrence of the defect is assessed,
when a threshold value for the estimation for the occurrence of the defect is exceeded on the basis of the overall estimated value then a second mode of operation is determined for the first sensing means and/or the at least one second sensing means, which second mode of operation is configured by means of the at least one first sensing parameter and the at least one second sensing parameter, and
re-determining the overall estimated value on the basis of the second mode of operation and re-assessing the occurrence of the defect therefrom.

2. The method as claimed in claim 1,
wherein the number of sensing means used is higher in the second mode of operation than in the first mode of operation.

3. The method as claimed in claim 1,
wherein the first mode of operation provides for a sensing by means of the first indicator and the at least one second indicator that involves the at least one first sensing parameter and the at least one second sensing parameter being chosen such that the reliability of the sensing is optimized.

4. The method as claimed in claim 1,
wherein the first mode of operation provides for a sensing by means of the first indicator and the at least one second indicator that involves the at least one first sensing parameter and the at least one second sensing parameter being chosen such that the current draw of the sensing is optimized.

5. The method as claimed in claim 1,
wherein the second mode of operation provides for a sensing by means of the first indicator and the at least one second indicator that involves the at least one first sensing parameter and the at least one second sensing parameter being chosen such that the accuracy of the sensing is optimized.

6. The method as claimed in claim 1,
wherein the overall estimated value on the basis of the first mode of operation and the overall estimated value on the basis of the second mode of operation are correlated with one another.

7. The method as claimed in claim 1,
wherein when the threshold value for the estimation for the occurrence of the defect is exceeded then a hypothesis for the type and/or bearing of the defect is determined that is used for determining the at least one first sensing parameter and the at least one second sensing parameter.

8. The method as claimed in claim 1, wherein the defect is a leak in the line.

9. The method as claimed in claim 1, wherein the defect is influenced by an event outside the line.

10. The method as claimed in claim 1,
wherein the position of the defect in or on the line is assessed from the overall estimated value.

11. The method as claimed in claim 1,
wherein the first estimated value is determined by means of the first estimation function and/or the at least one second estimated value is determined by means of the at least one second estimation function by an analysis apparatus.

12. The method as claimed in claim 1,
wherein the first sensing location of the first sensing means and the second sensing location of the at least one second sensing means are situated adjacently to one another and to the line within a distance of 40 m.

13. The method as claimed in claim 1,
wherein the first sensing means and/or the at least one second sensing means are formed by the performance of a visual inspection of the line using an imaging sensor in the optical and/or infrared range, in the first or second mode of operation.

14. The method as claimed in claim 1,
wherein the first sensing means and/or the at least one second sensing means are formed by the performance of a ground analysis of the surroundings of the line, or by a moisture sensor.

15. The method as claimed in claim 1,
wherein the first sensing means is formed by an analysis apparatus for weather data or environmental data.

16. The method as claimed in claim 1,
wherein the first indicator and the at least one second indicator represent mutually independent physical measured quantities, comprising pressure, motion and/or temperature.

17. The method as claimed in claim 1,
wherein the first indicator and the at least one second indicator represent a change of physical properties of the line, comprising material properties and/or properties regarding the ageing of material.

18. The method as claimed in claim 1,
wherein the overall estimation function is a Bayesian estimation function.

19. An apparatus for estimating the occurrence of a defect in a line, comprising:
at least one first sensing means, assigned to a first sensing location, that is designed to use a first estimation function to determine a first estimated value as at least one first indicator,
at least one second sensing means, assigned to a second sensing location, that is designed to use at least one second estimation function to determine at least one second estimated value as at least one second indicator,
an analysis apparatus having a processor and a memory, which analysis apparatus is designed to determine estimated values,
wherein the first and second sensing means are connected to the analysis apparatus, and
wherein the apparatus is designed to carry out the method as claimed in claim 1.

20. The method as claimed in claim 12,
wherein the first sensing location of the first sensing means and the second sensing location of the at least one second sensing means are situated adjacently to one another and to the line within a distance of 20 m.

21. The method as claimed in claim 12,
wherein the first sensing location of the first sensing means and the second sensing location of the at least one second sensing means are situated adjacently to one another and to the line within a distance of 10 m.
